(19) United States
(12) Patent Application Publication
(10) Pub. No.: US 2008/0245854 A1
(43) Pub. Date: Oct. 9, 2008

(54) Handheld electronic personal financial money manager and spending tracker

(76) Inventor: Deborah Monden, Fridley, MN (US)

Correspondence Address: Curtis D. Kinghorn;Sirius Strategic, LLC, 6769 W. Shadow Lake Dr., Lino Lakes, MN, 55014, US

(21) Appl. No.: 11/784,234

(22) Filed: Apr. 6, 2007

(51) Int. Cl. G06Q 40/00

(52) U.S. Cl. 235/379

(57) ABSTRACT

A device for aiding in the tracking and calculation of personal financial transactions is disclosed. The device is preferably pocket sized, portable and provides finger-tip access to allow the user to concentrate on managing the user's financial transactions and achieving financial goals with minimum effort. The device includes a central processing unit (CPU) that runs database software that stores information about the user's financial accounts, financial transaction histories, budgets, plans and goals. The CPU directs the device to visually present information about, including analytical information about, these financial categories. The present invention assists the user in tracking and recording their daily money inflows and outflows (e.g., via ATM or teller deposits and withdrawals, actual cash usage, debit card transactions, check writing activities). The device also allows the user to easily modify their budget and spending plans at any point of time to assist them in keeping on track of their financial goals. In a preferred embodiment of the invention, the device has about the same size as a common checkbook. The present invention eliminates the need for manual tracking and calculations of financial transactions, such as that done on paper checkbook ledgers, and provides pocket size, portable at the finger-tip access to the user's financial information to allow the user to concentrate on achieving their financial goals with minimum effort.

### BACKGROUND OF THE INVENTION

1. Field of the Invention

This invention relates to portable devices for aiding a user in managing their money, particularly with respect to spending.

2. Description of Related Art

Often times people end the month in the financial red (i.e., they have a negative balance on key financial accounts). Many people earn good salaries but never seem to know where they spent their money. As a result, they end up facing eviction, foreclosure, repossessions, late payments, etc. Many people believe tracking where and how they spend their money along with developing and following a budget and spending plan will get them on track financially. But, often times they lack the tools and the discipline to maintain their plan because they have to take the time to write down their purchases. In today's technology driven environment, many people don't have the time or inclination to write such things down. Plus, people are often in a rush and, although well intentioned, quite often forget to write these things down. But, it is believed that if they were supplied with a convenient device which requires minimum efforts to track their spending and follow a budget or spending plan (e.g., similar or equal to working the features offered on their cellular phone), consumers will be better equipped to manage their daily finances.

Office supply stores, manufacturers and electronic publishers commonly provide consumers with handheld PCs, PDAs and electronic schedule organizers. These devices are widely used by millions of consumers as reference devices for purposes such as time management, appointment schedulers, organizers, dictionaries and language translators. Yet, no manufacturer or inventor has provided consumers with an electronic, handheld personal financial organizer to assist consumers with managing their day-to-day money transactions.

The Rolodex® Electronics Touch-Screen PDA (RT-8214) incorporates an “expense manager” into its device. However, it only lets the consumer input their expenses without any regard to comparing these expenses to income, a budget or a spending plan or a combination of these. Further, this device does not provide any analysis of the expenses being tracked.

Most handheld electronic organizers' sole purpose is to provide a convenient location to store and organize information limited to listings of names, addresses, e-mails, phone numbers, appointments, meetings and things to do. With presently available devices, the input data cannot be manipulated to provide the user with valuable and useful details in real-time reporting as an electronic handheld device to assist them with their daily money management.

Some devices that are offered to the consumers are either paper or book format tools or personal computer software. Thus, there is a need for an easy to use device that allows the user to track important financial transactions in real-time and receive feedback on how the transaction affects the user's budget, financial goals or financial accounts or both.

### SUMMARY

A device for aiding in the tracking and calculation of personal financial transactions is disclosed. The device is preferably pocket sized, portable and provides finger-tip access to allow the user to concentrate on managing the user's financial transactions and achieving financial goals with minimum effort. The device includes a central processing unit (CPU) that runs database software that stores information about the user's financial accounts, financial transaction histories, budgets, plans and goals. The CPU directs the device to visually present information about, including analytical information about, these financial categories. The present invention assists the user in tracking and recording their daily money inflows and outflows (e.g., via ATM or teller deposits and withdrawals, actual cash usage, debit card transactions, check writing activities). The device also allows the user to easily modify their budget and spending plans at any point of time to assist them in keeping on track of their financial goals. In a preferred embodiment of the invention, the device has about the same size as a common checkbook.

The present invention eliminates the need for manual tracking and calculations of financial transactions, such as that done on paper checkbook ledgers, and provides pocket size, portable, at the finger-tip access to the user's financial information to allow the user to concentrate on achieving their financial goals with minimum effort. Consequently, it is an object of the invention in one or more embodiments of the invention to provide a device that:

Aids the user in the tracking and calculating the user's personal financial transactions;

Is pocket sized;

Is portable;

Provides finger-tip access to allow the user to concentrate on managing the user's financial transactions and achieving financial goals with minimum effort;

Includes a central processing unit (CPU) that runs database software that stores information about the user's financial accounts, financial transaction histories, budgets, plans and goals.

Displays information about, including analytical information about, the user's financial information.

Assists the user in tracking and recording their daily money inflows and outflows (e.g., via ATM or teller deposits and withdrawals, actual cash usage, debit card transactions, check writing activities).

Allows the user to easily modify their budget and spending plans at any point of time to assist them in keeping on track of their financial goals.

These and other objects and advantages of the invention will be clear in view of the following description to the invention including the associated drawings.

### BRIEF DESCRIPTION OF THE DRAWINGS

The invention will be described hereafter in detail with particular reference to the drawings. Throughout this description, like elements, in whatever embodiment described, refer to common elements wherever referred to and referenced by the same reference number. The characteristics, attributes, functions, interrelations ascribed to a particular element in one location apply to that element when referred to by the same reference number in another location unless specifically stated otherwise. All Figures are drawn for ease of explanation of the basic teachings of the present invention only; the extensions of the Figures with respect to number, position, relationship, and dimensions of the parts to form the preferred embodiment will be explained or will be within the skill of the art after the following description has been read and understood. Further, the exact dimensions and dimensional proportions to conform to specific force, weight, strength and similar requirements will likewise be within the skill of the art after the following description has been read and understood.

FIG. 1 is a perspective view of an embodiment of the invention.

FIG. 2 is a schematic view of the components of the invention.

FIG. 3 is a front view of the main menu screen of the invention.

FIG. 4 is a top view of the keyboard of the invention.

FIG. 5 is a front view of the “Track Expenses” screen of the invention.

FIG. 6 is a front view of the “Debt Register/Inventory Listing” screen of the invention.

FIG. 7 is a front view of the “Income Projection” screen of the invention.

FIG. 8 is a front view of the “Debt to Income” screen of the invention.

FIG. 9 is a front view of the “Budget” screen of the invention.

FIG. 10 is a front view of the “Checkbook Ledger” screen of the invention.

FIG. 11 is a front view of the “Account Reconciliation” screen of the invention.

FIG. 12 is a front view of the “Account Balances” screen of the invention.

FIG. 13 is a front view of the “Spending Plan” screen of the invention.

FIG. 14 is a front view of the “Bill Calendar” screen of the invention.

FIG. 15 is a front view of the “Financial Goals” screen of the invention.

FIG. 16 is a front view of a second “Financial Goals” screen of the invention.

FIG. 17 is a front view of the “View Reports & Analysis” screen of the invention.

FIG. 18 is a front view of the “Alerts/Warning Indicators” screen of the invention.

FIG. 19 is a front view of the “Priority Payment Plan” screen of the invention.

### DETAILED DESCRIPTION OF THE INVENTION

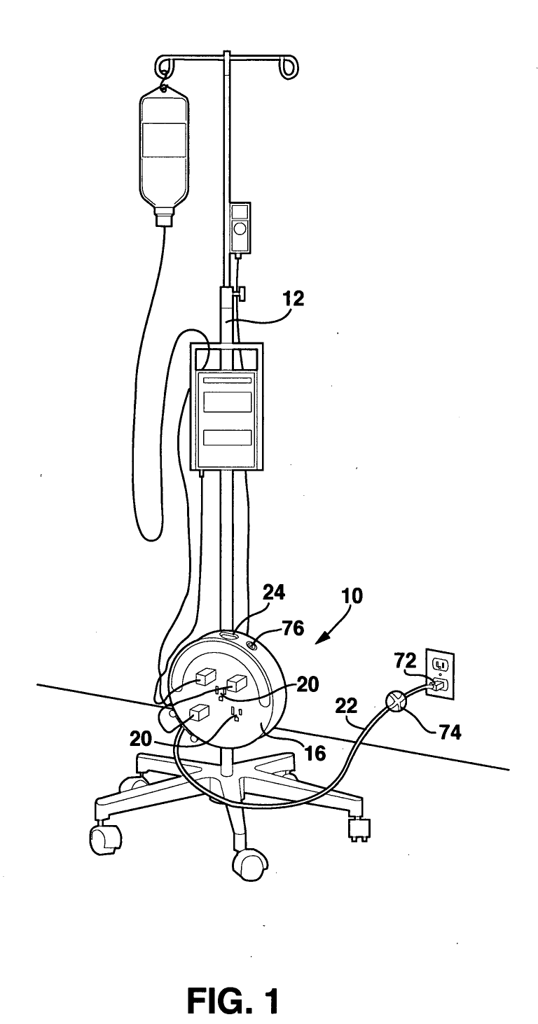

The present invention is shown in the drawings generally labeled 10. In a preferred embodiment of the device 10 shown in FIG. 1, the device 10 includes a keyboard 12 and display screen 14 that are connected along a common pivoting axis 16. In a most preferred embodiment of the device 10, the device 10 has about the same dimensions of a common checkbook and opens up so that the display screen 14 pivots around the common axis 16 towards or away from the keyboard 12. In this way, the display screen 14 provides a protective covering for the keyboard 12 in a closed configuration but allows the user to see valuable and useful information on the display screen 14 when in an open configuration.

The keyboard 12 may be a common QWERTY keyboard such as is commonly used with laptop computers, a 12 key keyboard such as is commonly used for cell phones or a custom keyboard with keys related to use for multiple functions (e.g., the keyboard on advanced calculators). The key function of the keyboard 12 is that it allows the user to easily input relevant data or activate key functions to be performed by the device 10. Consequently, any form of keyboard that allows the user to easily input relevant data and activate key functions may be used with the device 10. In a preferred embodiment of the device 10, the keyboard 12 has function specific buttons 18 that allow the user to access specific functions by merely pushing the appropriate function specific button 18 corresponding to the desired function.

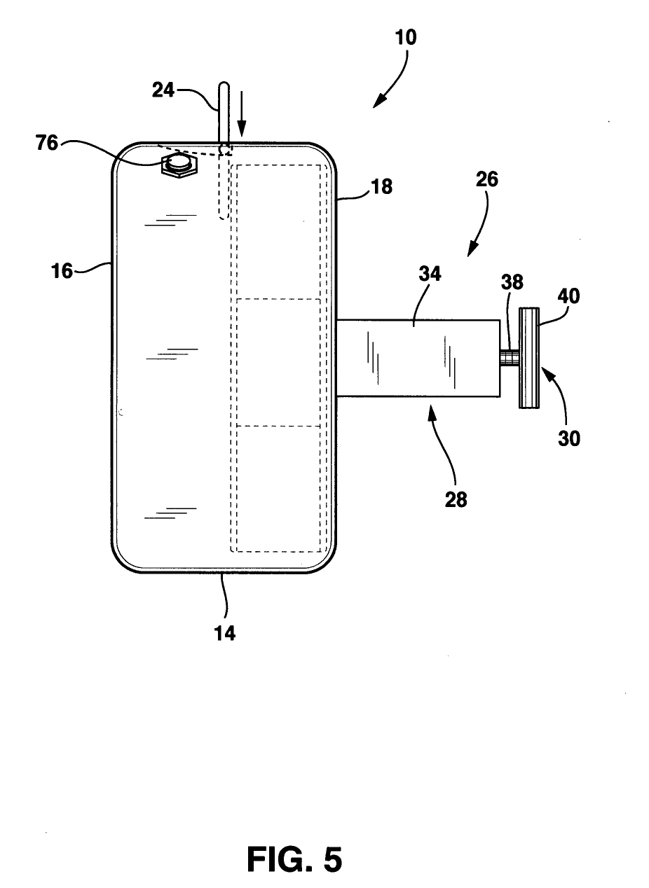

The device 10 also preferably includes a card reader 20. The card reader 20 is of the type commonly used with credit cards and is capable of reading either optical or magnetic strips that are on the back of credit cards. This allows the user to swipe the credit or debit card through the card reader 20 before or after using the card as part of a financial transaction. In this way, information about the card used during a transaction is entered into the device 10. Thereafter, a screen appears as shown in FIG. 5., showing the information about a financial transaction already input (e.g, the type of credit card used) and prompting the user to enter of the remaining information such as the amount of the transaction, type of transaction and store where the transaction occurred.

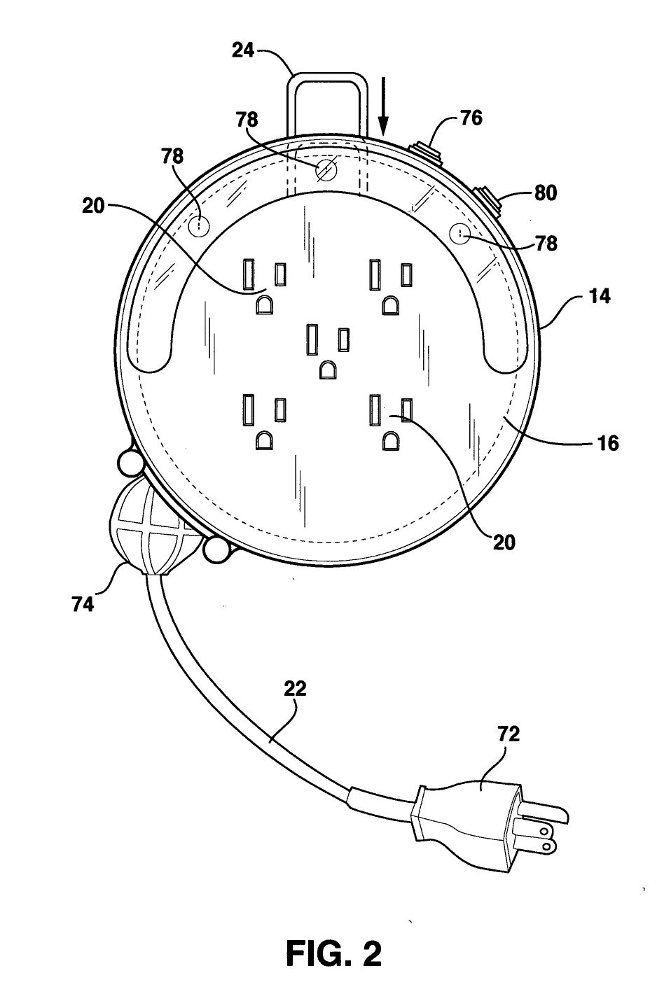

As shown in the schematic diagram of FIG. 2, the device 10 includes a central processing unit (CPU) 22 that is connected to the keyboard 12 and to the display screen 14. The CPU is preferably located in the housing of the keyboard 12 but may also be located in the housing of the display screen 14. The CPU 22 includes a memory 24 and a clock 26 and is capable of running software, particularly database software, that directs the operation of the device 10. The CPU 22 may be a microprocessor such as is commonly used in PDAs or laptops or may be an application-specific integrated circuit (ASIC). The key function of the CPU 22 is that it is able to receive input data, process the input data according to software instructions and export data, including through visual means, that is useful to the user. The memory 24 may be part of the CPU 22 or may be external to but connected to the CPU 22 as is commonly understood in such systems. Likewise, the clock 26 is preferably part of the CPU 22 although it may be external to but connected to the CPU 22 again as is commonly understood in such systems. The device 10, including the CPU 22 with all its associated components is preferably battery powered although the device 10 may be powered by household line current either directly or through an adaptor or may use the household line power to assist or recharge the batteries.

The device 10 also includes an input/output port 28 that is capable of connecting with other electronic devices such as laptop or personal computers, PDAs, cell phones or other similar devices. This input/output port 28 may take the form of a serial or parallel port, USB port, RS-232 port, infrared transceiver or any similar communication system as will be well understood by those skilled in the art.

In the preferred embodiment of the device 10, the display screen 14 is a common flat panel screen such as that commonly used on laptop computers or PDAs including, but not limited to LCD, plasma displays, OLEDs, laser displays, LEDs, ELDs, SEDs, FEDs and NEDs. In one embodiment of the device 10, the display screen 14 also includes a touchscreen 30 features that allow the user to input data merely by touching appropriate places on the display screen 14 with, for example, the user's finger or a stylus.

The device 10 also preferably includes a sensor 32 that senses when the display screen 14 is separated from or in near contact with the keyboard 12. Sensor 32 is preferably connected to CPU 22 so that in one embodiment, as the display screen 14 is moved away from the keyboard 12, the CPU 22 is activated. In another embodiment of the device 10, as the display screen 14 is moved away from the keyboard 12 a software switch is activated that allows the CPU 22 to be activated upon the pressing of an appropriate button on the keyboard 12 or a location on the display screen 14 where the display screen 14 includes a touchscreen 30. In any of these embodiments, as the display screen 14 is moved towards the keyboard 12, the sensor 32 alerts the CPU 22. As a result, the CPU 22 deactivates the display screen 14 and shuts down its own operations until activated by the moving of the display screen 14 away from the keyboard 12 as described above.

The software running on the CPU 22 includes software that allows a database of information to be established as is common for databases running on software. For each category of information (e.g., obligations, budget, income), one or more registers hold the appropriate information. For example, for each obligation that the user enters into the device, a register preferably holds information about the source of the obligation, the total amount due and the minimum monthly payment. The information stored in the database may be used in many different aspects of the user's financial profile. For example, the financial transaction of writing a check reduces the amount of money in the user's checking account, is part of the user's total spending for the month, may be compared to budgeted amounts for such transactions to name but a few examples of how a single transaction affects several different financial categories. Since databases, including financial databases, are well understood in the art, the details of their operation are omitted except to note that information is input, stored and manipulated and exported in a useful fashion as is commonly understood.

In this regard, the user can either enter information to be placed into the database from the keyboard 12 or by the touchscreen 30 on the display screen 14 or may present information to the CPU 22 through the input/output port 28 where the information is either input on another electronic device like a laptop computer or PC computer and passed to the CPU 22 or is exported from a program (e.g., the programs sold under the tradenames “QUICKEN” and “QUICKBOOKS” by Intuit, Inc.) running on the other electronic device such as the laptop computer or PC computer.

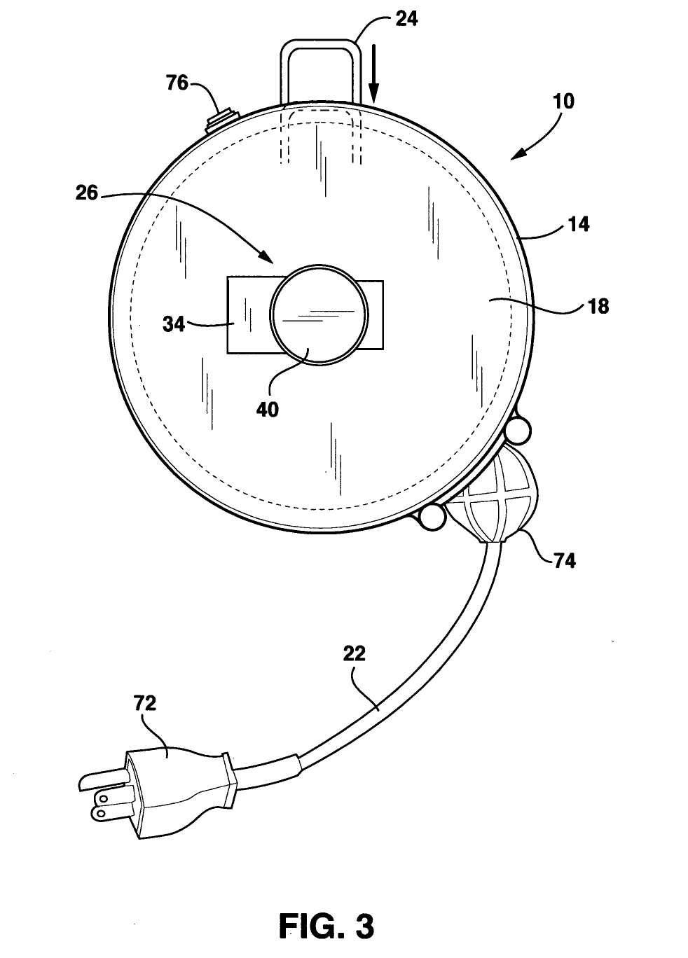

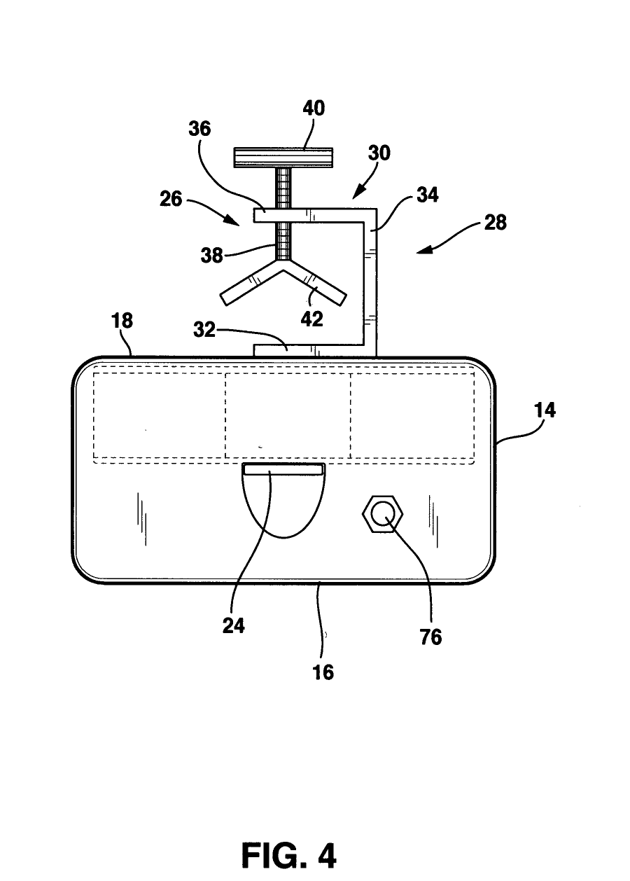

When the CPU 22 is activated as described above, the CPU 22 directs the display screen 14 to display an initial screen (shown in FIG. 3). This initial screen is the default screen for the device 10 and, in addition to being the screen that comes up when the device 10 is started, is also the screen that comes up when the “Main Menu” button (64) on the keyboard 12 is depressed. This initial screen shows the several available functions or categories of functions that are available to the user as a sort of “Table of Contents” to the device 10. For example, the following categories of functions are preferably displayed on the initial screen: “Track Expenses” (34), “Create a Debt Register/Inventory Listing” (36), “Enter Projected Income” (38), “Debt to Income” (40), “View Budget” (42), “Checkbook Ledger” (44), “Balance/Reconcile Account” (46), “View Account Balances” (48), “View Spending Plan” (50), “View Bill Calendar” (52), “Financial Goals” (54), “View Reports & Analysis” (56), “View Alerts/Warning Indicators” (58), “Prioritize Payments” (60), “Financial Calculator” (62) and “Main Menu” (64). Access to these functions is preferably accomplished by touching anywhere within the box containing these function names on the touchscreen 30 overlaying the display screen 14. Activating a function in this manner alerts the CPU 22 that the user desires to start the software sequence associated with the function being requested.

Alternately, a cursor may be moved around the display screen 14 by manipulation of keys on the keyboard 12 until the cursor is over a box containing a desired function. At that point, the user may select the desired function by hitting a button on the keyboard 12 such as the “Enter” button whereupon the CPU 22 is alerted to the fact that the user desires to activate a particular function. As a further alternative, each of these functions may have its own separate activation button 18 on the keyboard 12 so that merely pushing the relevant activation button 18 alerts the CPU 22 that the user desires to activate a particular function.

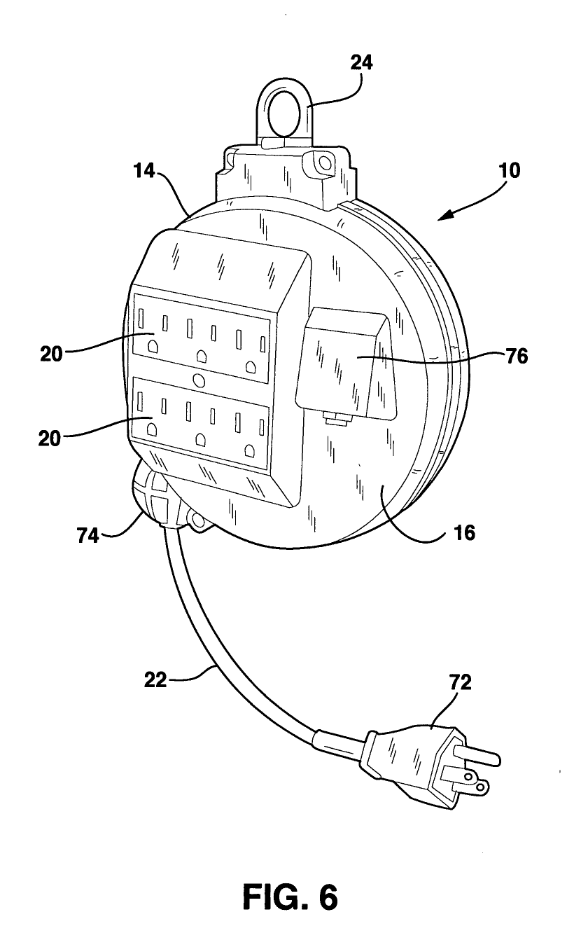

In any case, once the CPU 22 has been alerted that the user desires to activate a particular function, the CPU 22 directs software corresponding to the function to be activated. For example, if the user activates the function button entitled “Track Expenses” (34), the screen shown on FIG. 5 appears. On this screen, each transaction previously entered and its related information is shown. For example, for each transaction recorded, the date of the transaction, transaction description code (i.e., the type of transaction such as cash, check, ATM or debit card), the check number (if appropriate), amount of the transaction, purpose of the transaction (e.g., groceries, mortgage payment) and store or other location where the transaction occurred is shown. It is desirable to list the transaction description codes at the bottom of the page to aid the user in choosing and assessing the correct code. In this way, the user can observe when each transaction occurred, the type of transaction, the amount and purpose of the transaction, the check number if appropriate and the store or other location where the transaction occurred. Also, in this way, the user can see in an instant what transactions have occurred and their relevant information and be reminded of their transaction history. This “refreshing” of the user's memory may be useful to help the user from taking action that they wouldn't have taken had they had an accurate “picture” of their transaction history.

Where the user desires to activate the function “Debt Register/Inventory Listing” (36), the software running on CPU 22 directs the display screen 14 to display the screen shown in FIG. 6. As can be seen in FIG. 6, the due date, obligation, minimum balance due and total balance due on the obligation are listed. Further, the monthly totals for minimum balance to as well as the total balance due is also preferably shown at the bottom of the screen. In this way, the user can see what debt obligations they are facing in the current month. This allows the user to realize what their total monthly obligation is and to plan and act accordingly.

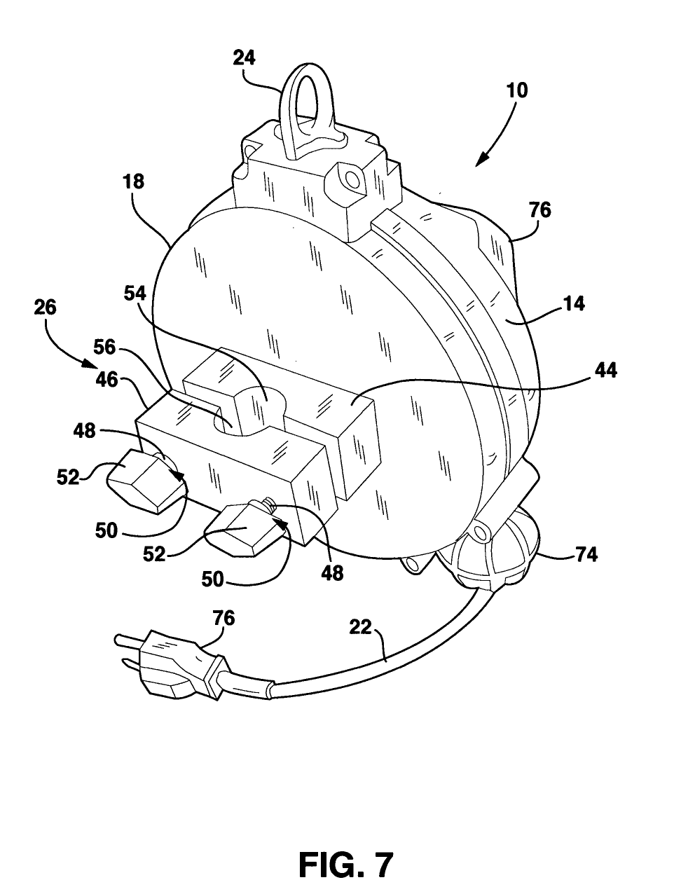

If the user activates the function button entitled “Enter Projected Income” (38) the screen shown on FIG. 7 is presented on the display screen 14. On this screen, the date the income is expected to be received is shown as well as the source of income and the amount of the income. The total amount of income expected in the month is also preferably shown at the bottom of the screen. In this way, the user can see what their projected income will be for the month so that they have an idea of what resources will be available to them in that month.

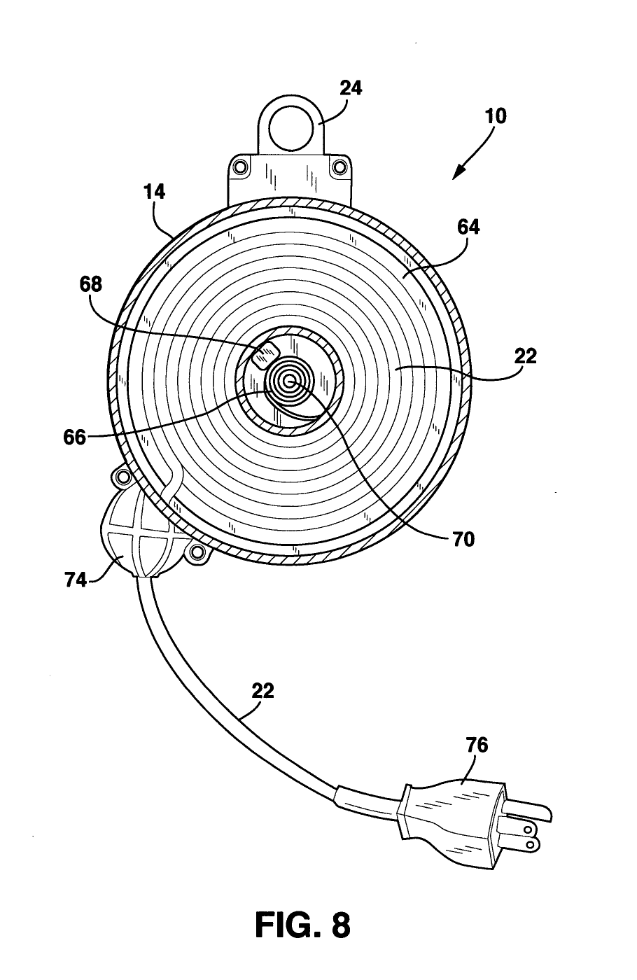

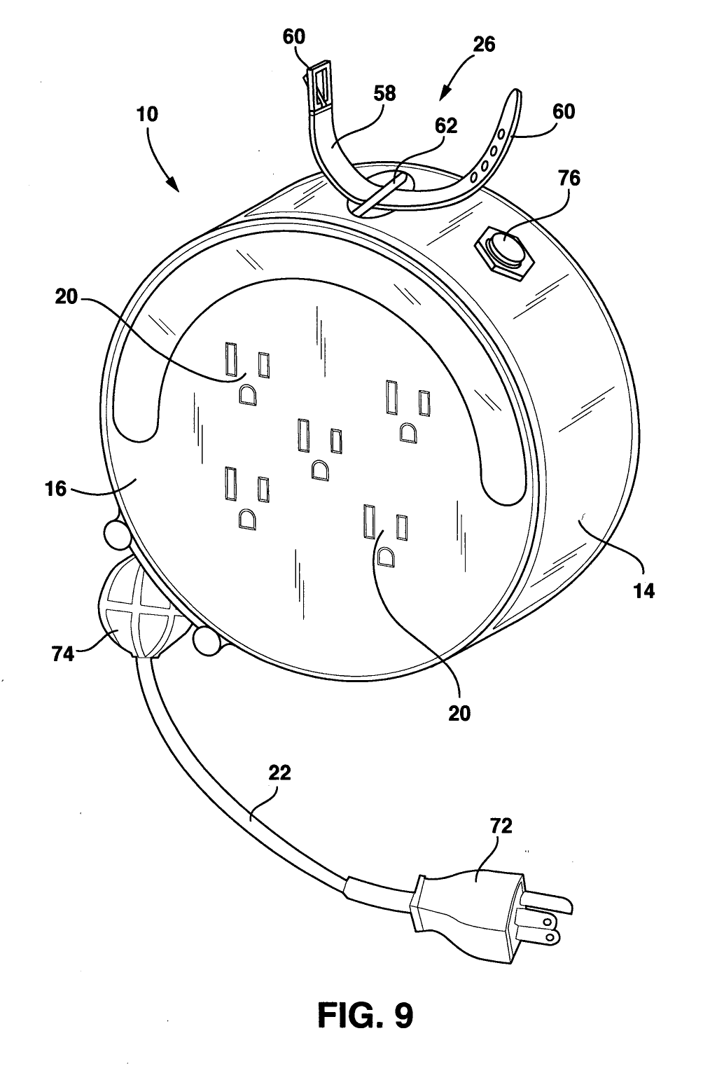

It may be desirable to compare projected debt obligations with projected income for a given month. In this regard, to do this the user can activate the button “Debt to Income” (40) whereupon the CPU 22 will direct the screen shown in FIG. 8 to appear on the display screen 14. On this screen, the projected debt expenses are presented in column form next to a column showing the percentage of such debt to the projected monthly income. On the left-hand side of this screen the user may preferably highlight certain categories of expenses (including an option to list all categories of expenses or all expenses) to appear under the projected debt column. Examples of categories of these expenses include, but are not limited to, housing, transportation, utilities, personal care items, household care items and groceries.

Where the user would like to activate the function “View Budget” (42), the screen shown in FIG. 9 appears on the display screen 14. On FIG. 9, the budget previously determined by the user is displayed listing projected income and expense. It is desirable to list the budget next to actual expenditures to see how the actual expenditures match up with the budgeted amounts in each of the budget categories. Consequently, the actual expenditures for the month, insofar as they have been incurred and entered into the device 10, are preferably displayed beside the budget. In addition, the variance from the budgeted amounts are also displayed so that the user can see how much they are above or below their budgeted amounts.

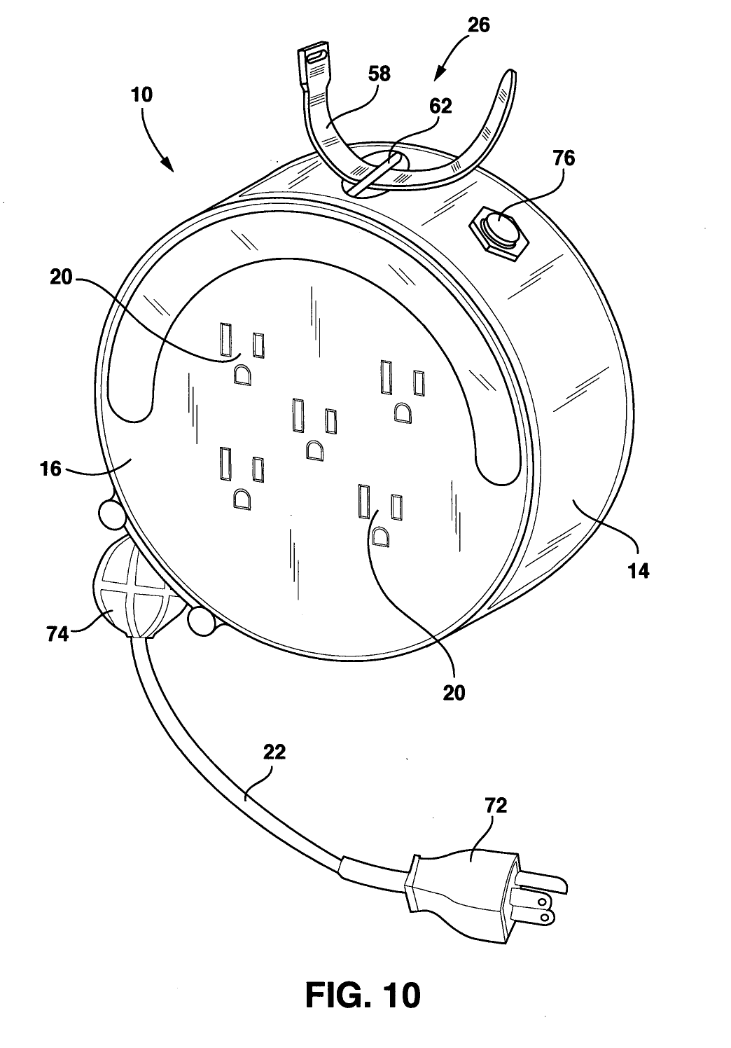

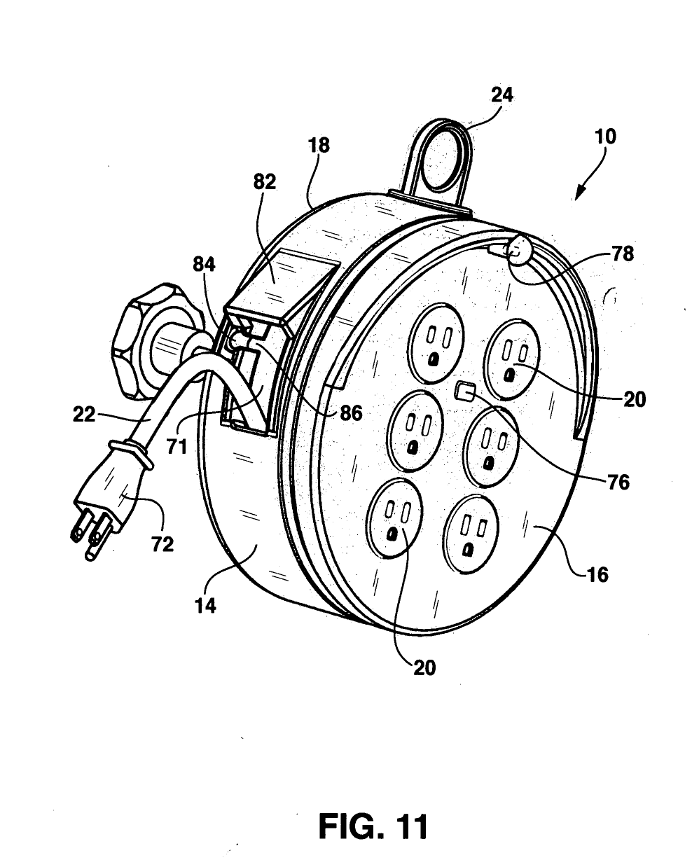

Another function that the user may activate is the “Checkbook Ledger” function. When the user desires to activate this function, they depress the “Checkbook Ledger” button (44). As a result, the screen shown in FIG. 10 appears on the display screen 14. The Checkbook Ledger screen produces a display resembling a common paper checkbook ledger having several columns labeled, payment type/check number, date, transaction description, deposit, payment amount/withdrawal, balance and code. The entries in the Checkbook Ledger are populated both manually and automatically depending on the transaction and the affect the transaction has on the user's checking account. For example, if the user manually enters on this screen that a check has been written but that check causes the user's checking account to be overdrawn, the CPU 22 may automatically direct that an entry be produced on this screen indicating that a charge for “non-sufficient funds” has been generated. Further, the status of check may be automatically populated based on the entries on the Track Expenses screen shown in FIG. 5 and Account Reconciliation Screen shown in FIG. 11 (e.g., “cleared bank,” “returned NSF,” “VOID,” “Resubmitted/Cleared” or “Resubmitted/Returned NSF”).

In a preferred embodiment of the device 10, the CPU 22 directs the display screen to automatically list checks in sequential numbering once a check number has been entered into the database or prompt the user to input data related to a particular check if a check number other than the next sequentially numbered check is entered.

It is intended that the user input data relating to each checkbook or debit card transaction through the keyboard 12, touchscreen 30 on the display screen 14 or through the card reader 14 or a combination of these although such information may be imported into the CPU 22 as described above. In any event, the transaction data is displayed on the screen shown in FIG. 11. As each bit of information is entered into the device 10, it appears on the Checkbook Ledger screen and is placed in an appropriate database register as is well understood in the database art.

Further, software running on the CPU 22 preferably prompts the user to input certain key information that has not yet been entered (e.g., the date of the transaction) to allow the user to enter all relevant information. The CPU 22 calculates the balance shown in the balance column by subtracting the amount of the transaction from the current checking account balance. In this way, the user is apprised of the current status of their checking account. This should allow the user to be alerted to when they are getting close to a zero or negative balance and to avoid entering into transactions that would place the user in a negative balance situation.

When the user desires to activate the “Account Reconciliation” function, the user activates the “Account Reconciliation” button (46) whereupon the screen shown in FIG. 11 appears on the display screen 14. On the screen shown in FIG. 11, the checkbook beginning balance appears at the top of the screen. Below this the deposits made and entered into the device 10 are shown one by one along with the total deposits made. Below this, all outstanding checks/transactions are listed so that the total deductions from the checking account are also listed. Finally, the net difference (i.e., the total amount of deposits minus total amount of deductions) is indicated as well as the resulting checking account balance (i.e., the beginning balance plus the total deposits minus the total withdrawals).

When the user desires to activate the “Account Balances,” the user activates the “Account Balances” button (48) whereupon the screen shown in FIG. 12 appears on the display screen 14. On the screen shown in FIG. 12, each account for which there is a balance is displayed along with the amount in that account. Where there are a lot of accounts, it may be desirable to categorize the accounts (e.g., by income accounts, expenses accounts) and may be desirable to subcategorize large categories (e.g., break the expense accounts into “Cash & Revolving Credit Accounts” and “Long Term Debt” accounts). It may also be desirable to indicate whether these accounts, particularly the relatively liquid accounts are increasing or decreasing over a particular time period. Consequently, in an embodiment of the device 10 the relative status of each liquid account (i.e., whether the account balance has increased or decreased) is displayed for desirable time periods (e.g., compared to last month and compared to the last three months) by indicating a “+” where the account has increased and a “−” where the account has decreased.

In addition to indicating just that a particular account has increased or decreased over a particular time period, it is desirable to know whether the account has increases or decreased by a little or a lot over the desired time period. In this regard, where the increase is modest (by some predetermined criteria), the increase is indicated by a single “+”. Where the increase is more substantial (again by some predetermined criteria), the increase is indicated by a double “++”. Finally, where the increase is very substantial (again by some predetermined criteria), the increase is indicated by a triple “+++”. Likewise, where the decrease is modest (by some predetermined criteria), the increase is indicated by a single “−”. Where the decrease is more substantial (again by some predetermined criteria), the increase is indicated by a double “−−”. Finally, where the decrease is very substantial (again by some predetermined criteria), the increase is indicated by a triple “−−−”. Of course, more or less or different symbols could be used. The key is that some symbol or combination of symbols represents increases or decreases in an easily decipherable way.

Where the user desires to activate the function “Spending Plan”, upon activating the “Spending Plan” (50) button causes the CPU 22 to displaying the screen shown in FIG. 13. In FIG. 13, weekly totals for both income and expenses are displayed, in column format as shown or in any other format that allows comparison between expenses and income. This Spending Plan is preferably automatically populated based upon the entries and selections the user has made in the Created Debt Register/Inventory Listing screen shown in FIG. 6, Enter Projected Income screen shown on FIG. 7, Financial Goals screen shown in FIG. 15 and Priority Payment Plan screen shown in FIG. 19.

Being able to see weekly expenses and income in close proximity allows the user to see whether sufficient money is available to meet all the user's obligations. If not, the user is able to revise their spending plan to ensure that adequate money is available as needed. To aid the user in determining whether sufficient money is available for each week, at the bottom of the page the net cash flow for each week is displayed. This allows the user to assess whether they will have positive cash flow of for that week or not and therefore allow them to arrange their affairs accordingly.

Where the user desires to see a “Bill Calendar,” the button labeled “Bill Calendar” (52) is activated whereupon the screen shown in FIG. 14 is shown on display 14. On the screen shown in FIG. 14, a monthly calendar shows the days of the month with highlighted reminders on specific days that certain bills are due. This screen will automatically populate based on the entries shown on the Debt Register/Inventory Listing screen shown in FIG. 6. In addition to the fact that a certain bill is due on a certain date, the amount of the bill may also be displayed. In this way, the user is reminded of upcoming bill due dates so that the bills can be timely paid. Further, the user is reminded that upcoming bills will be due so that the user may modify their spending habits to ensure that sufficient money is available to pay the bill in a timely manner.

Where the user activates the function “Financial Goals” by pushing the button labeled “Financial Goals” (54), the screen shown in FIG. 15 appears. On this screen, several possible financial goals are listed such as “Build Emergency Fund,” “Purchase A Home,” “Purchase A Car” or “Take A Vacation.” The user may select a particular financial goal whereupon the screen shown in FIG. 16 appears. In FIG. 16, the date the goals is to be accomplished, the total amount of savings accrued in the relevant account as well as the total amount needed to accomplish the financial goal is shown. In addition, the current amount in the relevant account compared to needed amount is also displayed, both as a percentage of the total amount and as a graphic visually showing the amount currently in the fund compared to the total amount needed to meet the financial goal. Examples of the form of visually displaying the amount currently in the funds compared to the total amount needed include, but are not limited to, a pie chart or side-by-side bar graphs.

It is also intended that information in the database of the device 10 may be presented to the user in the form of financial documents such as income statements, statements or cash flow and balance sheets. Consequently, there is a button on the keyboard 12 labeled “View Reports & Analysis” (56) that causes a screen like that shown in FIG. 17 to be displayed on display screen 14. Further, information on the comparison of the budgeted amounts versus actual amounts of some or all accounts, including variances, is also intended to be displayed by the device 10. In addition, percentage calculations and charts and graphs showing the financial status or history or both are also preferably displayed. Such financial documents and budget comparisons are commonly produced from financial databases so the details of how to produce such documents are not given herein.

As indicated, software running on the CPU 22 may also indicate when certain conditions have occurred or when the user is approaching certain conditions. For example, the device 10 is preferably equipped with several predefined priority alerts/warning indicators including, but not limited to overdraft alerts and over spending alerts to inform the user when the user's actual or proposed spending exceeds budgeted amounts. If the user desires to view these alerts/warnings the user may depress the button “View Alerts/Warnings” (58) whereafter the screen shown on FIG. 18 appears. These alerts or warnings will help the user to avoid taking undesired action and thereby avoid undesired financial consequences such as being overdrawn or having insufficient money to pay certain bills.

If the user desires to activate the function “Priority Payment Plan” by activating the button “Priority Payment Plan” (60), the screen shown in FIG. 19 appears. As can be seen in FIG. 19, the user is asked to select in which order the user considers certain bills to be important to be paid. As a result, a hierarchy of bill payment is established. So for example, as shown in FIG. 19, the user has selected mortgage/rent as the highest priority followed by utilities, food, transportation, childcare and other. The purpose of prioritizing these debts is to change the order of their listing on the Track Expenses screen shown on FIG. 5, Debt Register/Inventory Listing screen shown in FIG. 6, Budget screen shown in FIG. 9, Account Balances screen shown in FIG. 12 and Spending Plan shown in FIG. 13. By moving higher priority bills higher on the lists on these screens, the user is reminded of the importance of paying these bills.

It is also intended that the device 10 include a financial calculator. This financial calculator is preferably accessed by hitting the “Financial Calculator” button (62) on the initial screen. When this button is hit, the CPU 22 directs the display screen to display a financial calculator that includes at least the four arithmetic functions but which may also include other relevant financial functions, including but not limited to, percent calculations, memory storage, loan calculators and “time value of money” functions (e.g., future value, present value) and amortization schedule and debt to income ratios.

While the time periods for the various obligations, income streams, etc. has been listed as being a month, it is clear that the time period could be different from a month. For example, time periods of one or more weeks or more than one month as well as past weeks or months could also be incorporated into the device 10 either as a default or as an optional display. In this way, the user would be able to see information over virtually any time period that might be useful to the user.

As can be seen, the present invention assists money management challenged individuals or families in tracking spending, creating and managing a budget and spending plan and provides personal financial analyses to assist with money management, debt reduction and debt management utilizing a handheld electronic digital database organizer. The device 10 should help the user forecast their financial future and identify problem areas in time to develop strategies or plans to avoid the problems. In addition to providing statements, reports and plans (which are helpful to the user in their own right), the software operating on the CPU 22 preferably provides the user with helpful tips and step-by-step instructions to assist the user with reaching financial goals according to their personal priorities. As a result, a user of the device 10 should have better control over their financial affairs, manage their spending, avoid overdrafting their checking accounts and know where their money is being spent. Further, use of the device 10 will inform the user where they are financially, as well as will challenge them to reduce debt and redirect their spending in order to meet their financial objectives including, but not limited to, staying current with their bills.

In addition to helping the user track their actual spending or income, the software running on the CPU 22 also allows the user to enter “Proposed Transactions.” These Proposed Transactions can be either proposed purchases or income. The user can see what the effect would be on their finances by entering into the Proposed Transaction. For example, if the user proposes to make a certain purchase, the user enters the transaction as a “Proposed Purchase” by entering the transaction as though it were an actual transaction but, before completing the entry of the transaction, entering depressing the key “Proposed Transaction” 66 on the keyboard 12 that indicates to the CPU 22 that the transaction is a proposed not actual transaction. Thereafter the user can look at the effect of this Proposed Transaction of their financial condition by looking at the various screens as described herein. If the financial consequences are not desirable, the user can eliminate this “Proposed Transaction” by hitting the “Cancel Proposed Transaction” button 68 on the keyboard 12 whereupon the CPU 22 eliminates the Proposed Transaction and returns the database registers to the condition they had before entry of the Proposed Transaction. In this way, the user can ascertain the financial consequences of entering into a Proposed Transaction. If the user still wants to enter into the Proposed Transaction, the user may then either hit the Enter button 70 on the keyboard 12 to change the Proposed Transaction to an actual transaction or delete the Proposed Transaction as described above and enter the transaction details into the database as described above. In either case, the actual transaction data is entered into the database and the financial consequences determined as described herein.

In one embodiment of the device 10, to ensure the user's privacy, the device 10 may be equipped with security features that allow only the owner of the device to have access to the operation of the device 10. For example, voice recognition or a keypad security code or both may be used to ensure that unauthorized persons can't access, change or manipulate the data contained in the databases of the device 10.

Further, although specific reference has been made to managing checking accounts, it is clear that the device 10 can manage other types of accounts in addition to or in the alternative to checking accounts, the use of the checking account being an example of the kind of account that is readily managed by the device 10. For example, the device 10 can manage any financial account including, but not limited to, cash, checking, savings, money market and investment accounts.

Further, whether there is one or several accounts including different types of accounts, it may be desirable for the user to filter certain information about an account or accounts. For example, it is intended that the software running on the CPU 22 allow the user to filter or sort information in the database accounts by parameters including, but not limited to, transaction type, merchant, date or amount or any combination of these.

In addition, it is anticipated that the software running on the CPU 22 may include the ability to predetermine certain expenses or charges and enter them into the appropriate database registers. For example, some financial obligations require a monthly payment that is dependent on the amount owed. As the obligation is diminished over time by payments from the user, the minimum payment owed each month diminishes. However, the monthly amount is determined by formula. Consequently, it is intended that the device 10 be able to calculate the monthly payments due on such accounts based on calculating the amount by formula or by looking up the amount due in a lookup table or some combination of these. In any case, it is intended that the device 10 be able to calculate such minimum monthly payments due after the user has input parameters about the obligation such as the total amount owed at a particular time, the interest rate and the type of loan. It is also intended that once such an account is set up, the device 10 would be able to calculate the new minimum payment due based on the amount of the principal remaining in the account after paying the last payment.

Further, the device 10 also preferably includes the ability to apply overdraft or late charges to the appropriate accounts. These charges may be entered manually by the user or automatically calculated by the CPU 22 where the conditions triggering such charges are met as indicated by the user's transaction history that is entered into the device 10. These charges may be automatically calculated based on a formula, look up table data or a combination of these after initial information about the relevant account is entered into the device 10.

Several functions have been described herein as occurring automatically such as the calculation of minimum amounts due on an account or overdraft or late charges. There may also be interest payments due to the user for money held in certain accounts that may also be automatically calculated based on formulas or information stored in look up tables. There may be other information relevant to accounts that it may be useful or essential to know in order to calculate relevant information or to analyze an account. Consequently, it is intended that the device 10 be able to store such information about an account as will be necessary to determine such calculated or otherwise determined information. The device 10 may operate in a very simple mode with very little external information needed other than what the user inputs as described above. However, the device 10 may also operate in a wide spectrum of modes where the device 10 calculates more and more information or performs more and more analysis that requires increasing amounts of information about an account. In the case where additional information is required by the device 10 to make these calculations, it is preferred that the device 10 prompt the user for the information by displaying prompts on the display screen 14 and thereafter allowing the user to input the relevant information.

In the preferred embodiment of the device 10, the device 10 is preferably about the size and shape of a checkbook. As a result, it is relatively small, handheld and easily transportable in a pocket or purse, for example. However, the device 10 may take any form so long as it is easily transportable. Fore example, the device 10 may take the form of a device having dimension similar to a PDA or cell phone or may in fact be incorporated into a PDA or cell phone. Further, the device 10 may be made very thin using technology commonly applied to thin versions of cell phones or may have an increased thickness as desired.

The present invention has been described in connection with certain embodiments, configurations and relative dimensions. However, the description above is not to be construed as being absolutely particular or limiting. Instead, it is to be understood that the description given herein has been given for the purpose of explaining and illustrating the invention and is not intended to limit the scope of the invention. For example, additional methods of attaching the keyboard 12 to the display screen 14 or different keyboards 12 and display screens 14 could be implemented in the present invention and still be within the scope of the invention. There are many materials and configurations that can be used in constructing the invention by those skilled in the art including all types of CPUs 16, input/output ports 22 and database software. In addition, it is clear than an almost infinite number of minor variations to the form and function of the disclosed invention could be made and also still be within the scope of the invention. Consequently, it is not intended that the invention be limited to the specific embodiments and variants of the invention disclosed. It is to be further understood that changes and modifications to the descriptions given herein will occur to those skilled in the art. Therefore, the scope of the invention should be limited only by the scope of the claims.

1. A portable device for aiding a user in managing their money comprising:
a keyboard;
a display screen;
a central processing unit (CPU) connected to the keyboard and to the display screen, the CPU including a memory and a clock and running software, particularly database software, that directs the operation of the device, the database containing information relating to the finances of the user;
a power source connected to and powering the CPU, keyboard and display screen.

2. The device of claim 1 wherein the device has about the same dimensions as a common checkbook.

3. The device of claim 1 wherein the display screen is connected to the keyboard along a common pivoting axis wherein the display screen pivots around the common pivoting axis towards or away from the keyboard whereby the display screen provides a protective covering for the keyboard in a closed configuration but allows the user to see information on the display screen in an open configuration

4. The device of claim 1 further comprising a card reader connected to the CPU.

5. The device of claim 1 further comprising an input/output port that is capable of connecting with other electronic devices.

6. The device of claim 1 wherein the display screen includes a touchscreen that allows the user to input data merely by touching appropriate places on the display screen with the user's finger or a stylus.

7. The device of claim 1 wherein the CPU directs the display screen to display an initial screen upon activation of the CPU that displays the functions available to the user and allows the user to choose the function they desire to activate.

8. The device of claim 1 wherein, in response to a user request, the CPU directs the display screen to display a screen from the group consisting of:
showing the expenses and related data and allows the user to input additional information or correct the information shown on the display screen;
showing information relating to the user's financial obligations and allows the user to input additional information or correct the information shown on the display screen;
showing information relating to the user's projected income and allows the user to input additional information or correct the information shown on the display screen;
showing information relating to the user's financial obligations and projected income and allows the user to input additional information or correct the information shown on the display screen;
showing information relating to the user's determined budget and allows the user to input additional information or correct the information shown on the display screen;
showing information relating to financial transactions that are reported in a checkbook ledger and allows the user to input additional information or correct the information shown on the display screen;
showing information relating to the balances in the user's accounts and allows the user to input additional information or correct the information shown on the display screen; showing information relating to the user's accounts and allows the user to reconcile these accounts with other information the user has about the accounts;
showing information relating to the balances in the user's spending plan and allows the user to input additional information or correct the information shown on the display screen;
showing information relating to the timing of when financial obligations become due and allows the user to input additional information or correct the information shown on the display screen;
showing information relating to the user's financial goals and allows the user to input additional information or correct the information shown on the display screen;
showing information relating to the user's financial statements and allows the user to input additional information or correct the information shown on the display screen;
showing information relating to comparative features of the financial information stored in the database;
showing warnings or alerts relating to financial conditions contained in the database meeting certain predefined parameters.
showing the user's financial obligations due and allow the user to prioritize the payments of these obligations.

9. The device of claim 8 wherein when the CPU directs the display screen to display a screen showing information relating to the user's determined budget, the CPU directs the display screen to display, in addition to the user's budget, information about actual expenditures.

10. The device of claim 9 wherein when the CPU directs the display screen to display a screen showing information relating to the user's determined budget, the CPU directs the display screen to display, in addition to the user's budget and information about actual expenditures, the variance between the actual expenditures and the budget.

11. The device of claim 8 wherein when the CPU directs the display screen to display a screen showing information relating to financial transactions that are reported in a checkbook ledger, the CPU directs the display screen to automatically list checks in sequential numbering once a check number has been entered into the database.

12. The device of claim 8 wherein the CPU directs the display screen to prompt the user to input data related to a particular check if a check number other than the next sequentially numbered check is entered.

13. The device of claim 8 wherein the screen indicates whether these accounts are increasing or decreasing over a particular time period.

14. The device of claim 8 wherein projected net cash flows determined under the user's spending plan are displayed.

15. The device of claim 8 wherein the screen displays the information relating to the timing of when financial obligations become due in a calendar format.

16. The device of claim 8 wherein the information relating to the user's financial goals includes information relating to the ultimate financial goal and the current status of the account related to achieving the goal.

17. The device of claim 1 further comprising means for allowing the user to suggest a proposed financial transaction and see the results of the proposed transaction on the information contained in the database.

18. The device of claim 17 further comprising means for allowing the user to cancel the proposed transaction and reset the information in the database back to the condition of the information prior to the proposed transaction.

19. The device of claim 1 further comprising means for ensure the user's,privacy.

20. The device of claim 1 further comprising means for predetermining certain expenses or charges and entering them into the appropriate database registers.

21. A portable device for aiding a user in managing their money comprising:
a keyboard;
a display screen wherein the display screen includes a touchscreen that allows the user to input data by touching appropriate places on the display screen with the user's finger or a stylus and wherein the display screen is connected to the keyboard along a common pivoting axis wherein the display screen pivots around the common pivoting axis towards or away from the keyboard whereby the display screen provides a protective covering for the keyboard in a closed configuration but allows the user to see information on the display screen in an open configuration;
a central processing unit (CPU) connected to the keyboard and to the display screen, the CPU including a memory and a clock and running software, particularly database software, that directs the operation of the device, the database containing information relating to the finances of the user wherein the CPU directs the display screen to display an initial screen upon activation of the CPU that displays the functions available to the user and allows the user to choose the function they desire to activate;
a card reader connected to the CPU
a power source connected to and powering the CPU, keyboard, display screen and card reader;
wherein the device has about the same dimensions as a common checkbook.
